(19) United States
(12) Patent Application Publication
(10) Pub. No.: US 2013/0004706 A1
(43) Pub. Date: Jan. 3, 2013

(54) Cloth Structure Having Thermal and Stereoscopic Effects

(76) Inventor: Chen-Chiang Lee, Hsinchu-city (TW)

(21) Appl. No.: 13/171,791

(22) Filed: Jun. 29, 2011

(51) Int. Cl. B32B 7/00

(52) U.S. Cl. 428/119

(57) ABSTRACT

A cloth structure having thermal and stereoscopic effects in accordance with the present invention has a lining set as the inner surface, a surface fabric set as outer surface and an intermediate layer sandwiched between the lining and the surface fabric. The intermediate layer is made of fiber filaments laid and stacked in shape of continuous stretching fiber to perform the fiber body, which is heated to make the fiber filaments shrunk and combined with each other until the fiber body has a thickness suitable for manufacturing or optionally cut to become a thinner size. Thereby, the clothing made by the cloth structure has thermal and ventilating effects and moreover has excellent resilient, supporting and stereoscopic effects.

### BACKGROUND OF THE INVENTION

1. Field of the Invention

The present invention relates to a cloth, and more particularly to a cloth structure having thermal and stereoscopic effects.

2. Description of Related Art

Common coats, vests, jackets, and over-garments are made of a lining and a surface fabric and other materials respectively. To improve thermal and cold-defending effects, the space between the lining and the surface fabric is filled with fleece, down or other thermal materials. However, the filling fleece is not only has poor cold-defending efficiency but also is not laundry-durable, is water-decomposable and non-ventilative. The filling fleece is filled into the cloth by means of flatten spread which makes the fleece layer getting thinner by pressing after a period of time so that the quality of the cloth is not good enough for users. With regard to cloth filled with the down which provides the ventilative effect, the drawback is that the down is expensive in price and not easy to be dispersed evenly so that the cloth has some empty parts which influence the cold-defending efficiency.

### SUMMARY OF THE INVENTION

A main objective of the present invention is to have an intermediate layer laminated between a lining and a surface fabric of the cloth structure, wherein the intermediate layer is made of a fiber body composed of continuous erecting fiber filaments to make the cloth structure have thermal and ventilative effects to improve the warm-keeping efficiency under same thickness in comparison with conventional cloth and to have thin thickness and light weight under same warm-keeping efficiency.

A main objective of the present invention is to have an intermediate layer sandwiched between a lining and a surface fabric of the cloth structure, wherein the intermediate layer is made of a fiber body composed of continuous erecting fiber filaments to make the cloth structure have excellent resilient, supporting and stereoscopic effect and to achieve laundry-durable, non-deformable, and lifespan extension effects.

The present invention is to provide a cloth structure that is composed of a lining, a surface fabric and an intermediate layer, wherein the lining is set as the inner surface, the surface fabric is set as the outer surface and the intermediate layer is sandwiched between the lining and the surface fabric. The intermediate layer is made of fiber filaments laid and stacked in shape of continuous stretching fiber to perform the fiber body, which is heated to make the fiber filaments shrunk and combined with each other until the fiber body has a thickness suitable for manufacturing or optionally cut to become a thinner size. After laminating the intermediate layer between the lining and the surface fabric, all are combined together by mechanical sewing in check pattern (or strip pattern or various design patterns), glue or high-frequency welding with pressing wheel operationally.

Additionally, the intermediate layer is adjusted in denier or content of the fiber filaments to have different resilience for different requirements.

Moreover, each fiber filament has a cross-section in shape of crisscross, solid round or solid round with hollow parts (holes), wherein the intermediate layer has excellent warm-keeping efficiency when the fiber filament has the hollow parts.

Moreover, each fiber filament is further added with functional fiber such as far-infrared ray fiber (thermal efficiency) or bamboo carbon fiber (deodorization) to have more excellent functions.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a coat made of the cloth structure in accordance with the present invention;

FIG. 2 is an exploded perspective view with the cloth structure in FIG. 1;

FIG. 3 is a perspective view of the cloth structure I FIG. 1;

FIG. 4 is a cross-sectional view of one embodiment of the cloth structure in accordance with the present invention;

FIG. 5 is a cross-sectional side view of a first embodiment of a fiber filament

FIG. 6 is a cross-sectional side view of a second embodiment of the fiber filament; and

FIG. 7 is a cross-sectional side view of a third embodiment of the fiber filament.

### DETAILED DESCRIPTION OF THE PREFERRED EMBODIMENT

A cloth structure having thermal and stereoscopic effects in accordance with the present invention has a lining set as the inner surface, a surface fabric set as the outer surface and an intermediate layer sandwiched between the lining and the surface fabric. The intermediate layer is made of fiber filaments laid and stacked in shape of continuous stretching fiber to perform the fiber body, which is heated to make the fiber filaments shrunk and combined with each other until the fiber body has a thickness suitable for manufacturing or otherwise the fiber body is cut to become a thinner size. Thereby, the clothing made by the cloth structure has thermal and ventilating effects and further has excellent resilient, supporting and stereoscopic effects.

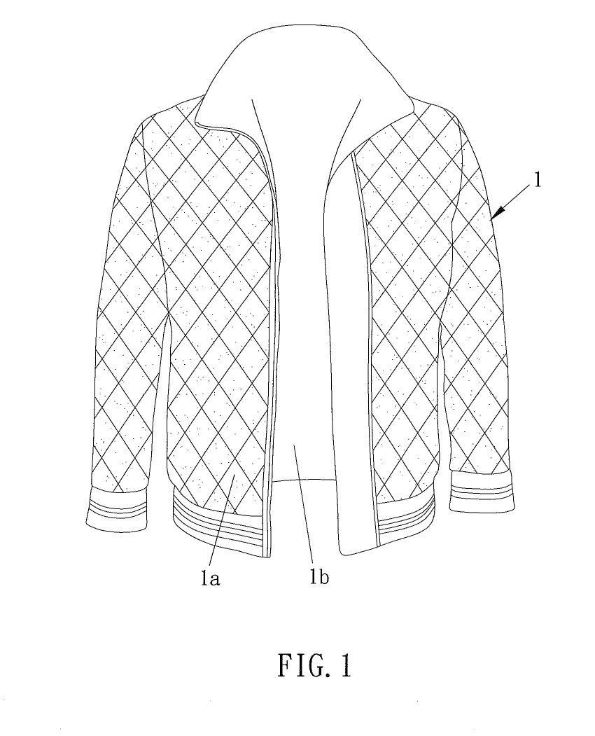

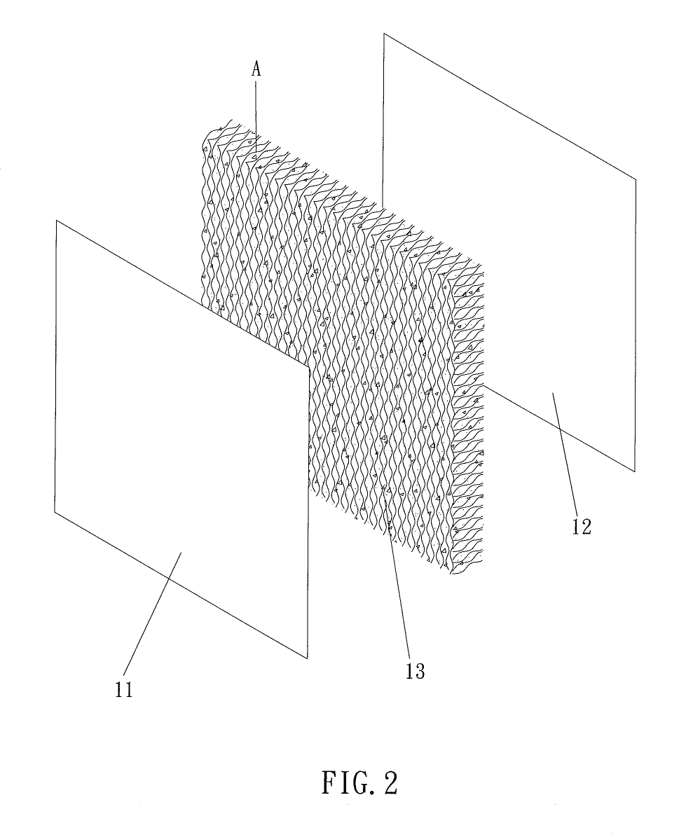

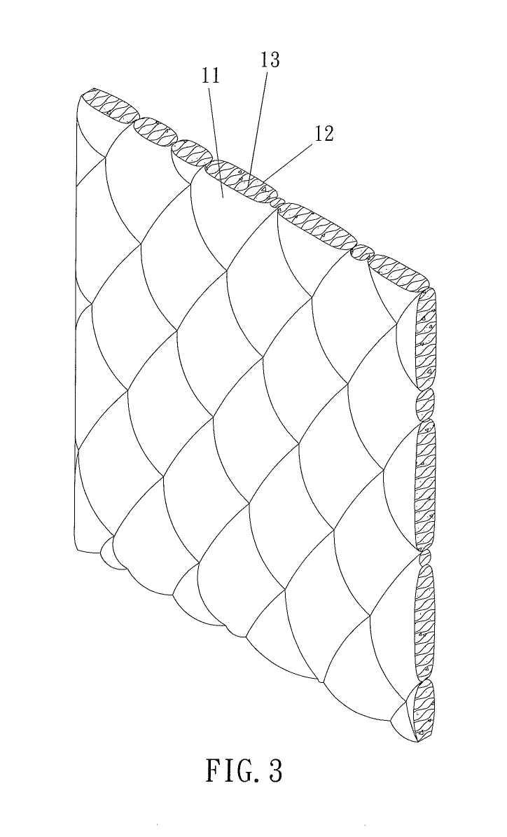

As shown in FIGS. 1 to 3, a preferred embodiment of a cloth structure 1 having thermal and stereoscopic effects in accordance with the present invention has an outer surface 1a and an inner surface 1b. The cloth structure 1 has a lining 11, a surface fabric 12 and an intermediate layer 13, wherein the lining 11 is set as the inner surface 1b, the surface fabric 12 is set as the outer surface 1a of the cloth structure 1, and the intermediate layer 13 is sandwiched between the lining 11 and the surface fabric 12. The intermediate layer 13 is made of fiber filaments opened and combined and then laid and stacked in shape of continuous stretching fiber to perform the fiber body A. The stretching fiber extends from the lining 11 to the surface fabric 12 and then is baked and heated to make the fiber filaments shrunk and combined with each other by thermal-fusing efficiency. Until the fiber body A becomes a sheet with suitable thickness (6-60 mm) for manufacturing, the sheet has resilient and high-recoverable effects. Optionally, the sheet is sliced into ones of thinner thickness (2-10 mm).

After laminating the intermediate layer 13 between the lining 11 and the surface fabric 12, the intermediate layer 13 is combined with the lining 11 and the surface fabric 12 by mechanical sewing in check pattern (or strip pattern or various design patterns), glue or high-frequency welding with pressing wheel operationally to achieve the cloth structure 1 in the present invention. The continuous stretching fiber of the intermediate layer 13 makes the cloth structure 1 to have thermal and ventilative effects and further excellent resilient, supporting and stereoscopic effects.

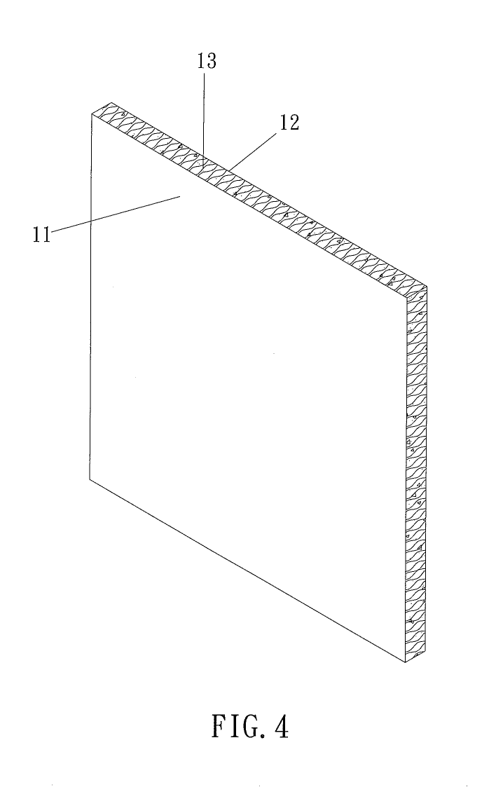

Additionally, the aforementioned intermediate layer 13 as shown in FIG. 4 is applied between the lining 11 and the surface fabric 12 and is combined with the lining 11 and the surface fabric 12 by glue or by high-frequency welding with pressing wheels to become one-piece.

The afore-mentioned intermediate layer 13 is adjusted in denier or content of the fiber filaments to have different resilience for different requirements.

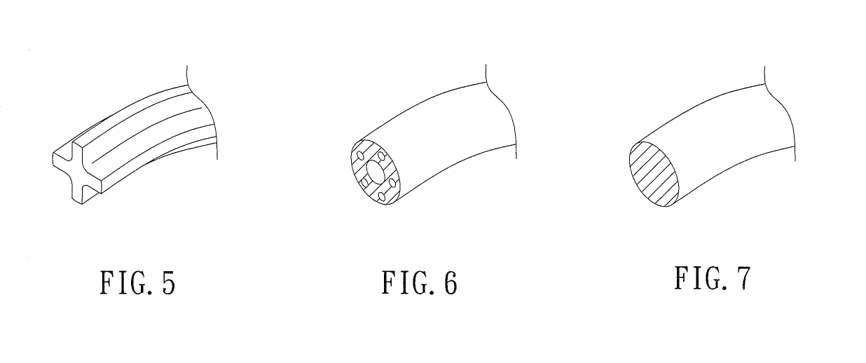

Moreover, as shown in FIGS. 5 to 7, each fiber filament of the intermediate layer 13 has a cross-section in shape of crisscross, solid round or solid round with hollow parts (holes). When the fiber filament has the hollow parts, the intermediate layer 13 has excellent warm-keeping efficiency. Additionally, each fiber filament is further added with functional fiber such as far-infrared ray fiber (thermal efficiency) or bamboo carbon fiber (deodorization) to have more excellent functions.

The afore-mentioned surface fabric 12 further has a ventilative membrane (having multiple tiny pinholes thereon) at its bottom layer. By size differences of the water molecule (large) and the vapor molecule (small), the thermal moisture of body is discharged but the water is prevented from entering into the cloth structure 1. Therefore, the cloth structure 1 is applicable to skiing, mountain-climbing, sporting, or out-door activity clothing, to achieve the warm-keeping, moisture-discharging, and water-proofing effects. The cloth structure 1 manufactured by glue or high-frequency welding is free from pinholes caused by mechanical sewing, which allow water permeate into the cloth structure 1.

By having the structure as described in the above embodiments, the cloth structure 1 of the present invention has the following advantages:
1. The cloth structure 1 in the present invention has the intermediate layer 13 sandwiched between the lining 11 and the surface fabric 12, wherein the intermediate layer 13 is made of the fiber body A composed by continuous stretching fiber to make the cloth structure 1 to posses both thermal and ventilative effects to improve the warm-keeping efficiency under same thickness in comparison with conventional cloth and to have thin thickness and light weight under same warm-keeping efficiency so that the users have good clothing quality.
2. The cloth structure 1 in the present invention has the intermediate layer 13 sandwiched between the lining 11 and the surface fabric 12, wherein the intermediate layer 13 is made of the fiber body A composed by continuous stretching fiber to make the cloth structure 1 to have excellent resilient, supporting and stereoscopic effects and to achieve laundry-durable, non-deformable, and lifespan extension effects.

Although this invention has been described in its preferred form with a certain degree of particularity, it is understood that the present invention of the preferred form has been made only by way of example and that numerous ii changes in the details of construction and the combination and arrangement of parts any be resorted to without departing from the spirit and scope of the invention.

What is claimed is:

1. A cloth structure with thermal and stereoscopic effects comprising:
an outer surface and an inner surface;
a lining set as the inner surface;
a surface fabric set as the outer surface; and
an intermediate layer sandwiched between the lining and the surface fabric, wherein the intermediate layer is made of fiber filaments laid and stacked in shape of continuous stretching fiber to perform the fiber body, which is heated to make the fiber filaments shrunk and combined with each other until the fiber body has a thickness suitable for manufacturing or otherwise the fiber body is optionally cut to become a thinner size;
wherein the continuous stretching fiber extends from the inner surface to the surface fabric;
wherein the intermediate layer is fixed with the lining and the surface fabric into one-piece.

2. The cloth structure as claimed in claim 1, wherein the intermediate layer is fixed with the lining and the surface fabric into one-piece by mechanical sewing in check pattern, strip pattern or various design patterns.

3. The cloth structure as claimed in claim 1, wherein the intermediate layer is fixed with the lining and the surface fabric into one-piece by glue.

4. The cloth structure as claimed in claim 1, wherein the intermediate layer is fixed with the lining and the surface fabric into one-piece by high-frequency welding with pressing wheel.

5. The cloth structure as claimed in claim 1, wherein the intermediate layer is adjusted in denier or content of the fiber filaments to have different resilience for different requirements.

6. The cloth structure as claimed in claim 1, wherein each fiber filament has a cross-section in shape of crisscross.

7. The cloth structure as claimed in claim 1, wherein each fiber filament has a cross-section in shape of solid round with hollow parts.

8. The cloth structure as claimed in claim 1, wherein each fiber filament has a cross-section in shape of solid round.
